(19) United States
(12) Patent Application Publication
(10) Pub. No.: US 2026/0317122 A1
(43) Pub. Date: Oct. 15, 2026

(54) METHOD OF MAINTAINING A PASSENGER CONVEYANCE SYSTEM OF A BUILING; USER INTERFACE FOR AN END DEVICE; AND END DEVICE

(71) Applicant: Otis Elevator Company, Farmington, CT (US)

(72) Inventors: Franck Rivoiret, Les bordes (FR); Frederic Beauchaud, Coullons (FR)

(21) Appl. No.: 19/407,769

(22) Filed: Dec. 3, 2025

(30) Foreign Application Priority Data
Apr. 11, 2025 (EP) 25305523.0

(51) Int. Cl. B66B 5/00

(52) U.S. Cl. CPC B66B 5/0031; B66B 5/0043

(57) ABSTRACT

A method of maintaining a passenger conveyance system (100) of a building. The method includes: a) connecting an end device (200) with a control device (120) of the passenger conveyance system (100) to be maintained; and b) receiving via the end device (200) information before or after starting a maintenance procedure in the passenger conveyance system (100) that supports a maintenance person (300) for conducting the maintenance procedure; wherein in step b) the received information causes a warning signal on the end device (200) to signal potential danger for the maintenance person (300) conducting the maintenance procedure.

### FOREIGN PRIORITY

This application claims priority to European Patent Application No. 25305523.0, filed Apr. 11, 2025, and all the benefits accruing therefrom under 35 U.S.C. § 119, the contents of which in its entirety are herein incorporated by reference.

### TECHNICAL FIELD OF INVENTION

The present disclosure relates to a method of maintaining a passenger conveyance system of a building, such as elevator, escalator and walkalator (or moving walkway) systems. The present disclosure also relates to a user interface for an end device, like a cellphone/smartphone, a tablet or a connected watch, and the end device itself.

### BACKGROUND OF THE INVENTION

It is generally known that there are a lot of maintenance activities to be performed during the lifecycle of the passenger conveyance system. Some of those activities require specific procedures to be followed. Therefore, some physical tags, for example, in plastic paper, are sticked on some key places to show and explain right procedures to carry out these activities in best and safe conditions, so that a maintenance person can see them and know exactly how to do.

In this respect, it is an object of the present disclosure to provide an enhanced method of maintaining a passenger conveyance system of a building.

### SUMMARY OF THE INVENTION

According to an aspect, a method of maintaining a passenger conveyance system of a building is provided. The method comprises: a) connecting an end device with a control device of the passenger conveyance system to be maintained; and b) receiving via the end device information before or after starting a maintenance procedure in the passenger conveyance system that supports a maintenance person for conducting the maintenance procedure; wherein in step b) the received information causes instructions for conducting the maintenance procedure on the end device (200); and/or wherein in step b) the received information causes a warning signal on the end device (200) to signal potential danger for the maintenance person (300) conducting the maintenance procedure.

Here, the passenger conveyance system includes elevator, escalator and walkalator (or moving walkway) systems and so on. By means of the method of the present disclosure, except the traditional way of using the physical tags, another way is provided to inform the maintenance person of the maintenance procedure of a maintenance activity. The method can also prevent the maintenance person from not looking at the maintenance procedure. In addition, the instructions here describes the maintenance procedure step by step on the end device so that the maintenance person can follow the instructions easily to conduct the maintenance procedure step by step in the passenger conveyance system. Moreover, the warning signal can draw the attention of the maintenance person to pay special attention to safety. Furthermore, the method can help the maintenance person to find the maintenance procedure even if the physical tags have been damaged.

According to an aspect, between step a) and step b) of the above method, a step of selecting the maintenance procedure of a group of different maintenance procedures via the end device is provided. Since all the maintenance procedures are stored in the end device in advance, the maintenance person can choose and retrieve a maintenance procedure as required. It enables the maintenance person to carry out the maintenance activity clearly and easily.

According to an aspect, when the passenger conveyance system is an elevator system, in step b), the received information may comprise a safety volume on top of or below a car of the elevator system to be inspected. This enables the maintenance person to know in advance whether the safety volume on top of or below the car of the elevator system is big enough to conduct the maintenance, and thus avoid some accidence under maintenance.

According to an aspect, the received information causes the warning signal on the end device, when the maintenance person enters a risky zone of the passenger conveyance system. This enables to draw the attention of the maintenance person to know that he/she is in a dangerous zone and should be very careful.

According to an aspect, the warning signal appears on the end device, when activating or deactivating a safety switch provided in the passenger conveyance system. This enables to draw the attention of the maintenance person that he/she is operating a safety switch.

According to an aspect, when the passenger conveyance system is an elevator system, the warning signal appears on the end device when a door of the car of the elevator system is opened and/or closed upon entry into a risky zone outside the car of the elevator system. This can further draw the attention of the maintenance person that he/she enters a dangerous zone in the elevator system.

According to an aspect, the present disclosure also provides a user interface for an end device, like a cellphone/smartphone, a tablet and a connected watch. Here, the user interface is provided to be connected with a control device of a passenger conveyance system to be maintained and is configured to execute the above method. By means of the user interface for the end device, the maintenance person can have easy access to the maintenance procedure as needed via the end device and follow it to conduct the maintenance procedure step by step during maintenance.

According to an aspect, the present disclosure further provides an end device comprising the above user interface. The end device enables the maintenance person to get easy access to the maintenance procedure at any time and at any place and not to depend on the physical tags any more.

### BRIEF DESCRIPTION OF THE DRAWINGS

Embodiments of the present disclosure, as an example only, will be described in the following with reference to the drawings. In the drawings:

FIG. 1 schematically illustrates a flow chart of a method of maintaining a passenger conveyance system of a building according to the present disclosure;

FIG. 2 shows a physical tag which illustrates all the processes when a maintenance person goes to the ceiling of an elevator system;

FIG. 3 shows a physical tag which illustrates all the processes when a maintenance person goes to the pit area of an elevator system;

FIG. 4 illustrates the receipt of a warning signal “ATTENTION” with a warning symbol on an end device when a maintenance is performed and a switch is deactivated/activated;

FIG. 5 illustrates visual instructions that are shown on a screen of the end device when a maintenance person opens a decorative ceiling of a car of the elevator system; and

FIG. 6 schematically illustrates a block diagram of an end device with a user interface prepared for working together with an elevator system.

### DETAILED DESCRIPTION OF THE INVENTION

In the following, embodiments of the present disclosure are explained with reference to the drawings. The same elements are assigned the same reference numbers in the drawings. It is to be noted that the embodiments are described for exemplary purposes only and the description of the embodiments is not intended to limit the scope of the present disclosure.

Usually, a passenger conveyance system 100 in a building can be operated in a normal operation mode and a maintenance mode. In the normal operation mode, the passenger conveyance system 100 works to transport the passengers to the different floors. In the maintenance mode, the passenger conveyance system 100 stops transporting the passengers and the maintenance person 300 performs maintenance on it.

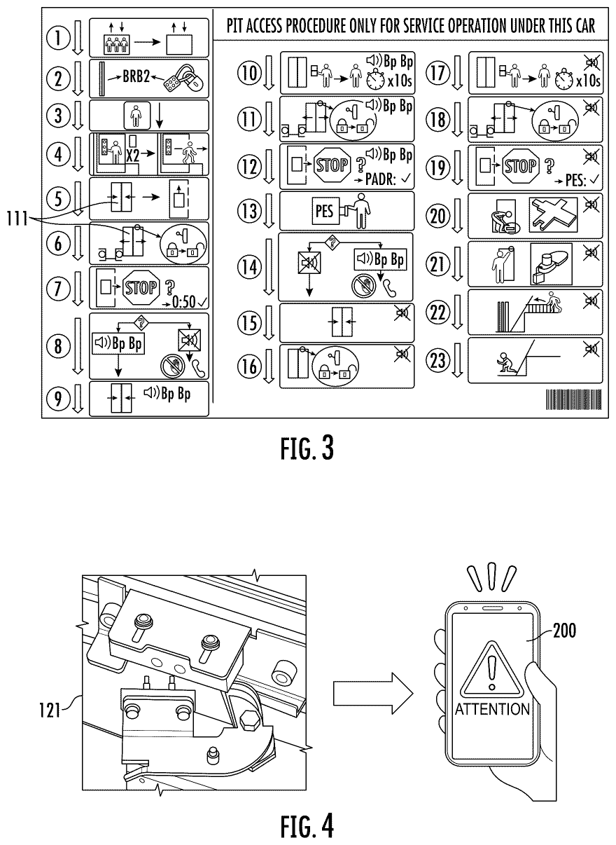

The passenger conveyance system 100 may include elevator, escalator and walkalator (or moving walkway) systems and so on. In practice, the maintenance person 300 performs the maintenance, for example, on the elevator system 100 based on certain instructions as shown in FIGS. 2 and 3. The present disclosure provides a method of maintaining a passenger conveyance system 100 of a building so that the maintenance person 300 can find these instructions as needed at any time to perform the maintenance properly.

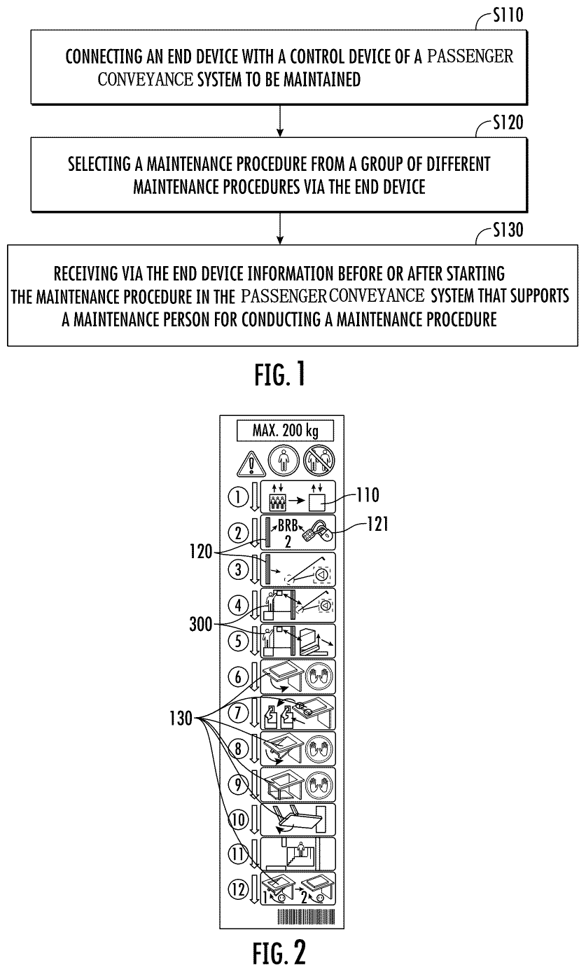

FIG. 1 schematically illustrates a flow chart of a method of maintaining a passenger conveyance system 100 of a building according to the present disclosure. The method of maintaining a passenger conveyance system 100 of a building comprises at least:
Step S110: connecting an end device 200 with a control device 120 of the passenger conveyance system 100 to be maintained.
Step S130: receiving via the end device 200 information before or after starting a maintenance procedure in this passenger conveyance system 100 that supports the maintenance person 300 for conducting the maintenance procedure.

Here, the end device 200 can be any kind of mobile terminal, like a cellphone/smartphone, a tablet, a connected watch, etc. The end device 200 gets preferably connected via Bluetooth or WIFI or a similar wireless way with the control device 120 of the passenger conveyance system 100 in order to give instantly information to the maintenance person 300. Before or after starting a maintenance procedure for the passenger conveyance system 100, the maintenance person 300 may receive via the end device 200 the information that supports him to conduct the maintenance procedure.

Optionally, the method according to the present disclosure further comprises a step S120 between S110 and S130: selecting the maintenance procedure of a group of different procedures via the end device 200. For example, different maintenance procedures can be stored in the control device 120 in advance and can be retrieved via the end device 200. The maintenance person 300 can then choose the maintenance procedure as needed, based on the maintenance place or components to be maintained.

According to step S130, the received information may cause instructions for conducting the maintenance procedure on the end device 200. Here, the instructions for conducting the maintenance procedure may be an audio and/or a visual description or a set of pictures in sequence to show the maintenance procedure step by step on the end device 200.

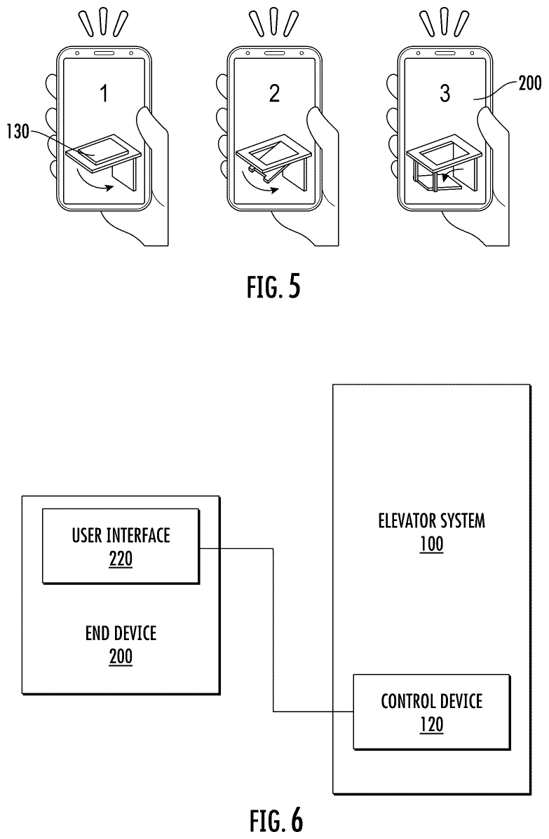

For example, FIG. 5 illustrates the visual instructions that are shown on the screen of the end device 200 when a maintenance person 300 has to open the decorative ceiling 130 of the elevator system 100 or the decorative ceiling of a car 110 of the elevator system 100. If he will perform maintenance here, then he can follow these visual instructions by step-by-step pictures. In addition, all the processes shown in FIG. 2 und 3 can also be illustrated one by one or in several pages on the screen of the end device 200. In this manner, the maintenance person 300 can follow the instructions easily to conduct the maintenance procedure properly and safety in any place in the elevator system 100, for example, on pit access, hoistway access by landing doors, low overhead balustrade deployment or any other risky intervention that need a specific access procedure.

Additionally, when the passenger conveyance system 100 is an elevator system, in step S130, the received information may comprise the visualization of a safety volume on top of or below a car 110 of the elevator system 100 to be inspected. In this manner, the maintenance person 300 is able to know in advance whether the safety volume on top of or below the car 110 of the elevator system 100 is big enough or how this safety volume look like to conduct the maintenance, and thus the risk of accident during maintenance can be reduced.

Furthermore, in step S130, the received information may cause a warning signal on the end device 200 to signal potential danger for the maintenance person 300 conducting the maintenance procedure. The warning signal may be activated on the end device 200 before, after or during maintenance of the passenger conveyance system 100, to remind the maintenance person 300 of the potential danger. For example, in the situations shown in FIGS. 4 and 5, when the maintenance person 300 opens the decorative ceiling 130, an alert may be firstly triggered to warn him that there are specific instructions for maintenance as mentioned above to follow.

The warning signal may be, for example, an audio alert like ”eep”, vocal alerts, vibration alerts, and/or a pop-up alert window. For example, in the processes 8 to 12 and 14 to 23 shown in FIG. 3, an audio alert like beeps or a vocal alert is triggered and appears respectively. FIG. 4 illustrates a warning signal “ATTENTION” with a warning symbol on the end device 200 when the maintenance is performed, and a vibration alert may also occur at the same time.

The warning signal can be triggered in many circumstances. For instance, when the maintenance person 300 enters a risky zone of the passenger conveyance system 100, the received information may cause a warning signal on the end device 200; when a safety switch 121 provided in the passenger conveyance system 100 is activated or deactivated, a warning signal may be triggered and appears on the end device 200; or when a door 111 of the car 110 of the elevator system 100 is opened or closed in the case that the maintenance person 300 enters into a risky zone outside the car 110 of the elevator system 100, a warning signal may be triggered and appears on the end device 200.

It should be noted that, while the preceding explanations were primarily made by using the elevator system as an example, the present disclosure also equally applies to escalator systems, moving walkways systems and other similar systems.

The present disclosure further provides the user interface 220 for the end device 200. As indicated in FIG. 6, the user interface 220 is provided to be connected with the control device 120 of the passenger conveyance system 100 to be maintained and is configured to execute the method, as explained above.

The present disclosure further relates to the end device 200 itself. The end device 200 comprises the above mentioned user interface 220.

What is claimed is:

1. Method of maintaining a passenger conveyance system (100) of a building, comprising:
a) connecting an end device (200) with a control device (120) of the passenger conveyance system (100) to be maintained; and
b) receiving via the end device (200) information before or after starting a maintenance procedure in the passenger conveyance system (100) that supports a maintenance person (300) for conducting the maintenance procedure;
wherein in step b) the received information causes instructions for conducting the maintenance procedure on the end device (200);
and/or wherein in step b) the received information causes a warning signal on the end device (200) to signal potential danger for the maintenance person (300) conducting the maintenance procedure.

2. Method according to claim 1, wherein between step a) and step b) a step of selecting the maintenance procedure of a group of different maintenance procedures via the end device (200) is provided.

3. Method according to claim 1, wherein the instructions describes the maintenance procedure step by step on the end device (200).

4. Method according to claim 1, wherein in step b), the received information comprises a safety volume on top of or below a car (110) of an elevator system (100) to be inspected.

5. Method according to claim 1, wherein the received information causes the warning signal on the end device (200), when the maintenance person (300) enters a risky zone of the passenger conveyance system (100).

6. Method according to claim 1, wherein the warning signal appears on the end device (200), when activating or deactivating a safety switch (121) provided in the passenger conveyance system (100).

7. Method according to claim 1, wherein the warning signal appears on the end device (200) when opening and/or closing a door (111) of a car (110) of an elevator system (100).

8. User interface (220) for an end device (200), like a cellphone, a tablet and a connected watch, wherein this user interface (220) is provided to be connected with a control device (120) of a passenger conveyance system (100) to be maintained and is configured to execute the method according to claim 1.

9. An end device (200), comprising a user interface (220) according to claim 8.
